(19) United States
(12) Patent Application Publication
(10) Pub. No.: US 2007/0189486 A1
(43) Pub. Date: Aug. 16, 2007

(54) COMMUNICATION APPARATUS, SYSTEM, METHOD AND COMPUTER READABLE MEDIUM

(75) Inventor: Kotaro Ise, Saitama-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/469,722

(22) Filed: Sep. 1, 2006

(30) Foreign Application Priority Data
Feb. 2, 2006 (JP) 2006-25608

(51) Int. Cl. H04M 3/42

(52) U.S. Cl. 379/201.12

(57) ABSTRACT

There is provided with a communication apparatus connected to a first network on which service providing servers are disposed, including: a service finder configured to find a service providing server on the first network; and a transmitter configured to transmit an information packet including a header part and a data part to a packet relay apparatus which connects the first network to a second network, wherein the header part contains an address of the found service providing server and a port number at which the found service providing server waits, as a source address and a source port number and an address of an information processing server disposed on the second network and a port number at which the information processing server waits, as a destination address and a destination port number, and the data part contains service identification information which identifies a service provided by the found service providing server.

### CROSS-REFERENCE TO RELATED APPLICATIONS

This application is based upon and claims the benefit of priority from the prior Japanese Patent Applications No. 2006-25608 filed on Feb. 2, 2006, the entire contents of which are incorporated herein by reference.

### BACKGROUND OF THE INVENTION

1. Field of the Invention

The present invention relates to a communication apparatus, a communication system, a communication method and a computer readable medium, for example, to a technique for causing a plurality of computers to perform cooperative operation via a NAT (Network Address Translation) apparatus.

2. Related Art

In recent years, it has become possible to implement remote control in which screen information transmitted from a remote computer is displayed on a terminal at hand and the remote computer is controlled by using a mouse or a keyboard connected to the terminal at hand. As examples, the X window system developed by X.org Foundation, the function of Microsoft Corporation called Remote Desktop, and VNC (Virtual Network Computing) software can be mentioned. Instead of drawing the screen of the remote computer on the terminal at hand by transmitting and receiving drawing commands as in the X window system, it is also possible to construct a similar system by performing image-coding of the screen of the remote computer according to the MPEG2-TS and decoding and displaying a result on the terminal at hand.

Furthermore, fast communication is made possible by development of the Internet even if two points are at a long distance between.

In general, a computer having a fast CPU and a large-capacity hard disk is heavy and is not suitable for carrying. On the other hand, in a light-weighted computer suitable for carrying, the CPU has a comparatively slow capability and the hard disk has a small capacity.

However, it is possible to control the remote computer by utilizing the remote control scheme on the Internet. It is possible to access data stored in a hard disk having a large capacity and perform processing using a fast CPU while the light terminal is used.

JP-A 2003-288536 (KOKAI) discloses a method of transferring map data from a remote map data server to a car navigation terminal at hand and displaying a map on the car navigation terminal. A destination place is input to the car navigation terminal at hand, and this information is sent to the map data server. By receiving map data of the desired place, a map of the desired place can be displayed on the car navigation terminal at hand. As a result, it is not necessary to equip the car navigation terminal with a storage having a large capacity. Such an architecture in which most of calculation processing and data storage is entrusted to the remote computer and the terminal at the user's hand performs only light processing as an IO device which presents a processing result transmitted from the remote computer to the user or accepts a keyboard or mouse input from the user, is spreading in its applied region as networks in recent years become fast. This architecture has an advantage that the terminal at hand can be formed of hardware having a low processing capability, because most processing is performed by the remote computer. In this architecture, in the case where a system department in an enterprise manages the remote computer and users are employees, or in the case where an ASP (application service provider) manages the remote computer and lends out computer resources to users, even if application is more sophisticated and higher calculation capability is needed, it is necessary to raise only the processing capability of the remote computer without raising the processing capability of the terminal at user's hand. Therefore, this architecture has an advantage that it is possible to save users labor to update the hardware.

Broadcast or multicast is used to find a nearby device or service, as in, for example, NetBIOS used in Windows (trademark) which is an OS of Microsoft Corporation or UPnP standardized by UPnP Forum. The remote control scheme has a problem that unless a remote terminal belongs to the same IP subnetwork as the terminal at hand, a broadcast packet cannot be transmitted and received between the remote terminal and a computer near the terminal at hand and a remote computer cannot find a device or service near the terminal at hand. A protocol using multicast to find a device or service also has a problem that the remote computer cannot find a device or service near the terminal at hand, because a TTL of a multicast packet is set to a small value or the network does not support transfer of multicast packets in many cases. For example, even if there is a UPnP AV server that retains video contents near the terminal at hand, therefore, the remote computer cannot find the UPnP AV server and the video contents in the UPnP AV server cannot be displayed on the terminal at hand, resulting in a problem.

A similar problem is present in the above-described JP-A 2003-288536 (KOKAI) as well. Since the remote map data server cannot find a device located near the car navigation terminal at hand, information obtained by utilizing service provided by the device cannot be displayed on the car navigation terminal at hand.

It is also possible in the conventional technique to set, for example, a L2TP tunnel between the terminal at hand and the remote computer and to perform virtualization so as to cause the remote computer to belong to the same subnetwork as the terminal at hand does, in order to find service near the terminal at hand. In this case, however, data communication at the time when the remote computer uses service located near the terminal at hand is also performed through the L2TP tunnel. This results in a problem that the transfer processing of the data communication performed by the remote computer must be performed by the terminal at hand. Especially, as the network becomes faster and the data quantity of the data communication increases, the processing load becomes heavy and the CPU power the terminal at hand should have also increases, resulting in a problem.

This results in a problem that the user must upgrade the processing capability of the terminal at hand if the quantity of data communication performed by the remote computer is increased by sophisticated application, resulting in complicatedness.

If a NAT (Network Address Translation) apparatus is present between the server and the remote computer, the remote computer cannot access the server, resulting in a problem. In order to solve this problem, for example, IP-A 2005-102316 (KOKAI), IP-A 2005-130453 (KOKAI), and JP-A 2005-137018 (KOKAI) are disclosed. According to these methods, however, it is necessary to change the program or configuration of the server itself. This results in a problem that the development cost is needed and a problem that these methods cannot be applied to already existing servers.

In JP-A 2003-108449 (KOKAI), a system in which an intermediary server is provided in a home network is described. In this system as well, however, it is necessary to change the program or configuration of the server itself in these methods. This results in a problem that a development cost is needed and a problem that these methods cannot be applied to already existing servers. In addition, it is necessary to newly provide the intermediary server, resulting in a problem of an increased cost.

### SAMMARY OF THE INVENTION

According to an aspect of the present invention, there is provided with a communication apparatus connected to a first network on which one or more service providing servers are disposed, comprising:

a service finder configured to find a service providing server on the first network; and

a transmitter configured to transmit an information packet including a header part and a data part to a packet relay apparatus which connects the first network to a second network, wherein the header part contains

an address of the found service providing server and a port number at which the found service providing server waits, as a source address and a source port number and

an address of an information processing server disposed on the second network and a port number at which the information processing server waits, as a destination address and a destination port number, and

the data part contains service identification information which identifies a service provided by the found service providing server.

According to an aspect of the present invention, there is provided with a communication system including a communication apparatus connected to a first network on which one or more service providing servers are disposed, and an information processing server connected to a second network which is connected to the first network via a packet relay apparatus, wherein

the communication apparatus comprises:

a service finder configured to find a service providing server on the first network; and

a transmitter configured to transmit an information packet including a header part and a data part to the packet relay apparatus, the header part containing an address of the found service providing server and a port number at which the found service providing server waits as a source address and a source port number and containing an address of the information processing server and a port number at which the information processing server waits as a destination address and a destination port number, the data part containing service identification information which identifies a service provided by the found service providing server, and

the information processing server comprises:

a receiver configured to receive the information packet from the communication apparatus via the packet relay apparatus;

an exhibitor configured to exhibit information to identify the service providing servers respectively;

a selector configured to select a service providing server based on the information exhibited; and

a transmitter configured to transmit a request packet to request implementation of the service provided by the service providing server selected to the service providing server selected, and perform data communication concerning said service with the service providing server selected, wherein the request packet has a header part containing an address of the service providing server selected and a port number at which the service providing server waits as a destination address and a destination port number and containing own address and a port number for implementing the data communication as a source address and a source port number.

According to an aspect of the present invention, there is provided with a method performed in a communication apparatus connected to a first network on which one or more service providing servers are disposed, comprising:

finding a service providing server on the first network; and

transmitting an information packet including a header part and a data part to a packet relay apparatus which connects the first network to a second network, wherein the header part contains an address of the found service providing server and a port number at which the found service providing server waits as a source address and a source port number, and an address of an information processing server disposed on the second network and a port number at which the information processing server waits as a destination address and a destination port number, and the data part contains service identification information which identifies a service provided by the found service providing server.

According to an aspect of the present invention, there is provided with a computer readable medium storing a computer program for causing a computer connected to a first network on which one or more service providing servers are disposed, to execute instructions to perform steps of:

finding a service providing server on the first network; and

transmitting an information packet including a header part and a data part to a packet relay apparatus which connects the first network to a second network, wherein the header part contains an address of the found service providing server and a port number at which the found service providing server waits as a source address and a source port number, and an address of an information processing server disposed on the second network and a port number at which the information processing server waits as a destination address and a destination port number, and the data part contains service identification information which identifies a service provided by the found service providing server.

### BRIEF DESCRIPTION OF THE DRAWINGS

FIG. 1 is a diagram showing a typical configuration of a first embodiment according to the present invention;

FIG. 2 is a diagram showing an example of a Nat translation state table;

FIG. 3 is a diagram showing an example of a communication sequence in a first embodiment;

FIG. 4 is a diagram showing contents of an SSDP search packet;

FIG. 5 is a diagram showing contents of a SSDP search response packet;

FIG. 6 is a diagram showing an example of a Description document;

FIG. 7 is a diagram showing an example of a browse request;

FIG. 8 is a diagram showing an example of a browse response;

FIG. 9 is a diagram showing a configuration example of a NAT apparatus;

FIG. 10 is a diagram showing a configuration of a computer disposed on an external network;

FIG. 11 is a diagram showing a display example of icons representing found service devices;

FIG. 12 is a diagram showing a typical configuration of a second embodiment according to the present invention;

FIG. 13 is a diagram showing an example of a communication sequence in a second embodiment;

FIG. 14 is a diagram showing titles of two multimedia data displayed on a screen of a display terminal;

FIG. 15 is a diagram showing a configuration example of a display terminal; and

FIG. 16 is a diagram showing a configuration of a main body apparatus disposed on an external network.

### DETAILED DESCRIPTION OF THE INVENTION

Hereafter, embodiments of the present invention will be described with reference to the drawings.

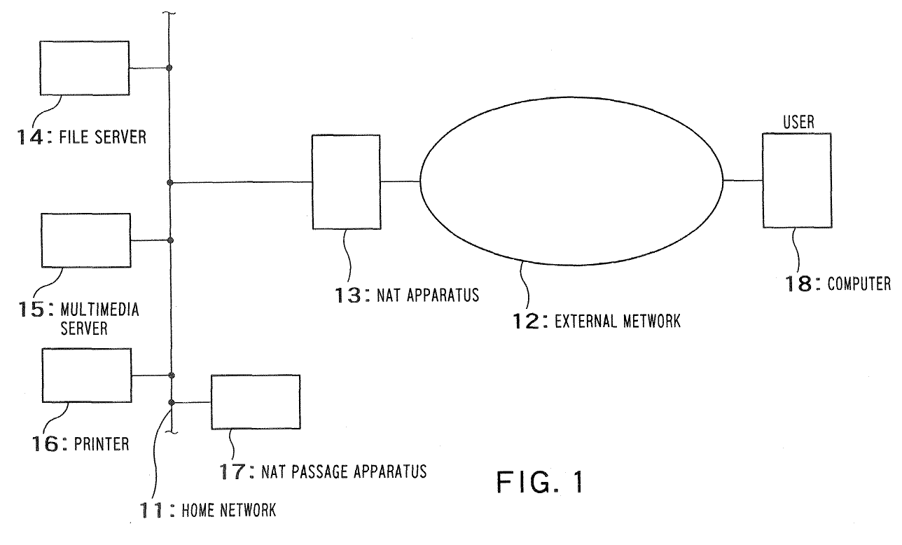

FIG. 1 is a diagram showing a typical configuration of a first embodiment according to the present invention.

A home network (first network) 11 and an external network (second network) 12 are connected to each other via a NAT apparatus (packet relay apparatus) 13. A file server 14, a multimedia server 15, a printer 16 and a NAT (Network Address Translation) passage apparatus 17 are connected to the home network 11. A computer (information processing server) 18 is connected to the external network 12. The computer 18 is controlled by the user. The file server 14, the multimedia server 15 and the printer 16 are equivalent to, for example, a service providing server.

The NAT apparatus 13 translates a source address and a source port number of a packet received from the home network 11 to different values, and transmits the resultant packet to the external network 12. At this time, NAT apparatus 13 stores (destination address, source address, protocol number, destination port number, and source port number) of the packet received from the home network 11 and (destination address, source address, protocol number, destination port number, and source port number) of the packet transmitted to the external network 12 into a Nat translation state table in the NAT apparatus 13.

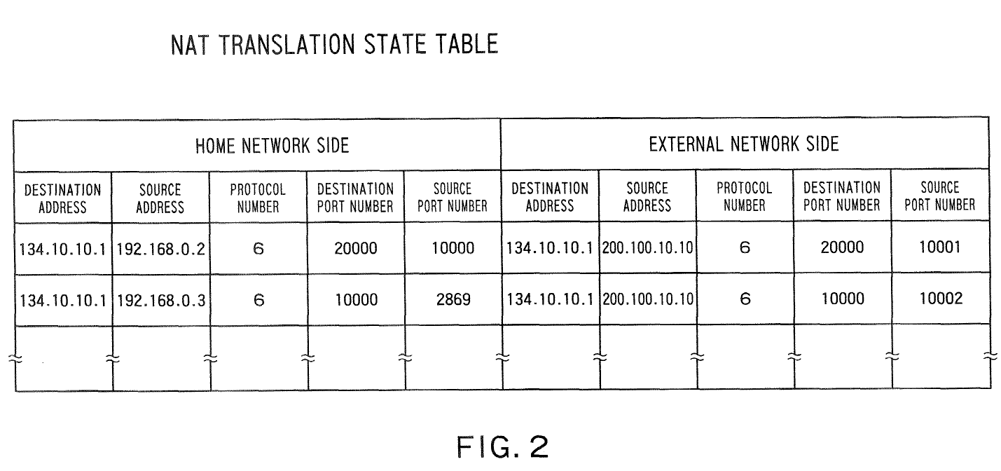

FIG. 2 shows an example of the Nat translation state table.

Values of (destination address, source address, protocol number, destination port number, and source port number) of the received packet are described on the home network side, and values of (destination address, source address, protocol number, destination port number, and source port number) of the transmitted packet are described on the external network side. FIG. 2 shows as an example of the case where a packet having (134.10.10.1, 192.168.0.2, 6, 20000, 10000) as (destination address, source address, protocol number, destination port number, and source port number) is received from the home network 11, the packet is translated to a packet having (134.10.10.1, 200.100.10.10, 6, 20000, 10001) as (destination address, source address, protocol number, destination port number, and source port number), and the packet is transmitted to the external network 12. Here, it is desirable that the source address 200.100.10.10 of the packet is an address assigned to the NAT apparatus 13.

On the other hand, upon receiving a packet from the external network 12, the NAT apparatus 13 searches for an entry in which (destination address, source address, protocol number, destination port number, and source port number) of the received packet coincide with (source address, destination address, protocol number, source port number and destination port number) of values on the external network side in the Nat translation state table. If there is a coinciding entry, the NAT apparatus 13 translates (destination address, source address, protocol number, destination port number, and source port number) of the received packet to values of (source address, destination address, protocol number, source port number and destination port number) on the home network side of the entry, and transmits a packet obtained by the translation to the home network 11 side.

If there isn't a coinciding entry in the Nat translation state table when the NAT apparatus 13 has received a packet from the external network 12, then the NAT apparatus 13 discards the received packet.

As a result, it is possible to start communication from a device connected to the home network 11 to a device connected to the external network 12. However, it is not possible to start communication from a device connected to the external network 12 to a device connected to the home network 11.

If the NAT apparatus 13 does not receive a packet corresponding to an entry in the Nat translation state table for a definite time period, the NAT apparatus 13 deletes this entry.

The file server 14 advertises existence of itself to the home network 11 by using NETBIOS. Upon finding the existence of the file server 14 by a method described later, it becomes possible for the computer 18 to access a file provided by the file server 14 by using CIFS (Common Internet File System).

The multimedia server 15 advertises the existence of itself to the home network 11 by using UPnP (Universal Plug and Play). Upon finding the existence of the multimedia server 15 by a method described later, it becomes possible for the computer 18 to access contents, such as, for example, a moving picture file, provided by the multimedia server 15 by using HTTP.

The printer 16 advertises the existence of itself to the home network 11 by using UPnP or a protocol unique to each enterprise. Upon finding the printer 16 by a method described later, it becomes possible for the computer 18 to transmit printing data to the printer 16 by using, for example, HTTP and print desired data by using the printer 16.

What is common to servers, such as the file server 14, the multimedia server 15 and the printer 16, is to transmit an advertisement packet which advertises itself by using a multicast packet or a broadcast packet. This advertisement packet is transmitted periodically. The transmitted packet contains an address and a port number, or a URI (Universal Resource Identifier), to be used in subsequent communication. Even if these data are not contained in the advertisement packet, subsequent communication is performed by using a source address in a header contained in the advertisement packet in some cases. In this case, a transmission port number is determined previously.

In order for another device to search for the file server 14, the multimedia server 15 or the printer 16 actively, a device having a function of multicasting or broadcasting a search packet is also present. This device (transmitting device) can transmit the search packet at arbitrary timing. Upon receiving the search packet and recognizing that the subject of the search of the packet is itself, a receiving device transmits a search response packet to the transmitting device of the search packet by using the unicast.

The search response packet can also be transmitted by using multicast or broadcast. By causing the search response packet to contain an address and a port number, or a URI (Universal Resource Identifier), to be used in subsequent communication, it becomes possible for a receiving device that has received the search response packet to access the file server 14, the multimedia server 15, or the printer 16.

The NAT passage apparatus 17 finds a device that provides service, by receiving an advertisement packet based on NETBIOS, UPnP or another protocol, and stores an address and a port number contained in the advertisement packet.

The NAT passage apparatus 17 transmits an open packet toward an address and a port number of an external apparatus (an apparatus on the external network 12) stored previously. At this time, a source address and a source port number of the open packet are provided with the same values as those of the address and port number contained in the advertisement packet.

The NAT passage apparatus 17 may prevent an entry from being deleted from the Nat translation state table in the NAT apparatus 13 by transmitting this open packet periodically.

The computer 18 disposed on the external network 12 knows that a service device (server) is present in the home network 11 by receiving the open packet (information packet). The computer 18 transmits a packet having (source address, destination address, protocol number, source port number and destination port number) of the received open packet as (destination address, source address, protocol number, destination port number, and source port number). As a result, it becomes possible for the computer 18 to access the desired server.

### (Description of Sequence)

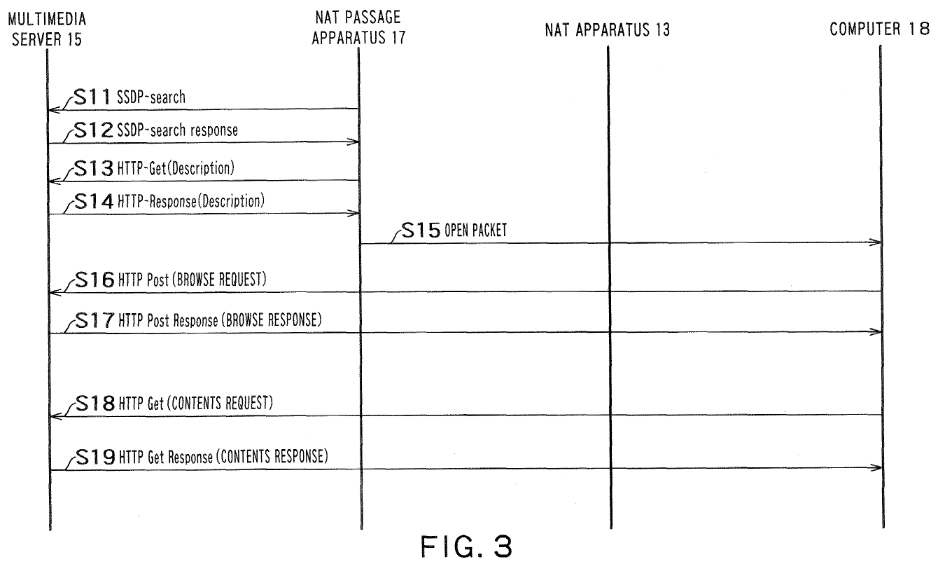

FIG. 3 shows an example of a communication sequence according to the present embodiment.

The NAT passage apparatus 17 transmits an SSDP search packet as a search packet (S11).

(Destination address, destination port number, and protocol number) of the SSDP search packet are (239.255.255.250, 1900, 17). Its source address is the address of the NAT passage apparatus 17, and its source port number is a value determined by the NAT passage apparatus 17 on the basis of the state at each time.

The SSDP search packet is transmitted as a UDP packet.

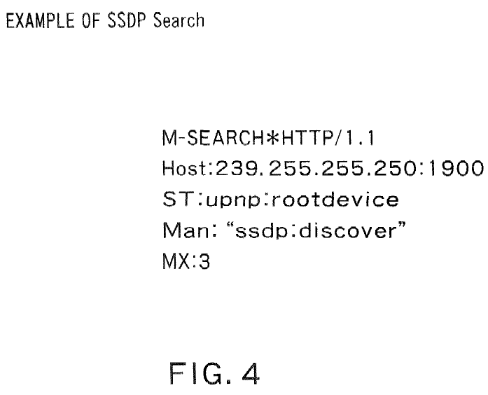

FIG. 4 shows contents of a data part (data field) of the UDP packet. In FIG. 4, “ssdp:discover” on a Man tag indicates that the packet is a search packet, and “upnp:rootdevice” on an ST tag indicates that a UPnP device is being searched for.

Upon receiving the SSDP search packet, the multimedia server 15 returns an SSDP response packet toward the NAT passage apparatus 17 (S12).

The SSDP response packet is transmitted as a UDP packet.

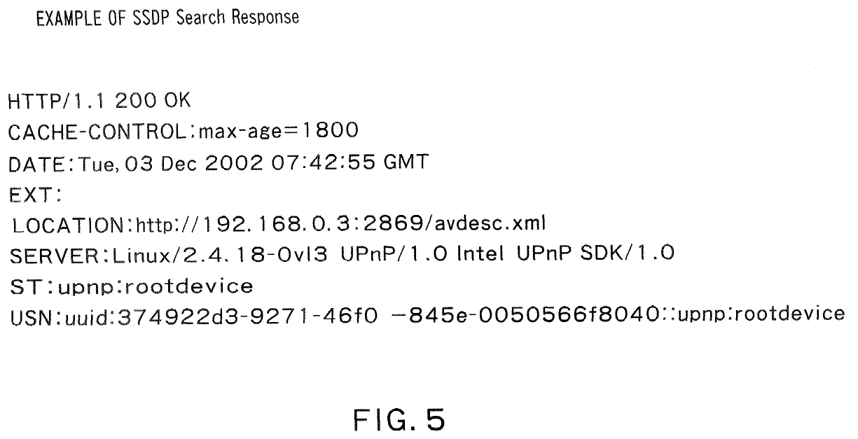

FIG. 5 shows contents of a data part of the UDP packet.

In FIG. 5, “http://192.168.0.3:2869/avdesc.xml” on a LOCATION tag serves as a URL for acquiring a Description document.

The NAT passage apparatus 17 performs HTTP GET toward the URL (S13). Upon receiving the HTTP GET, the multimedia server 15 returns an HTTP GET Response containing a Description document (S14).

The Description document has a description of a kind of service provided by the server and a URL for accessing the service.

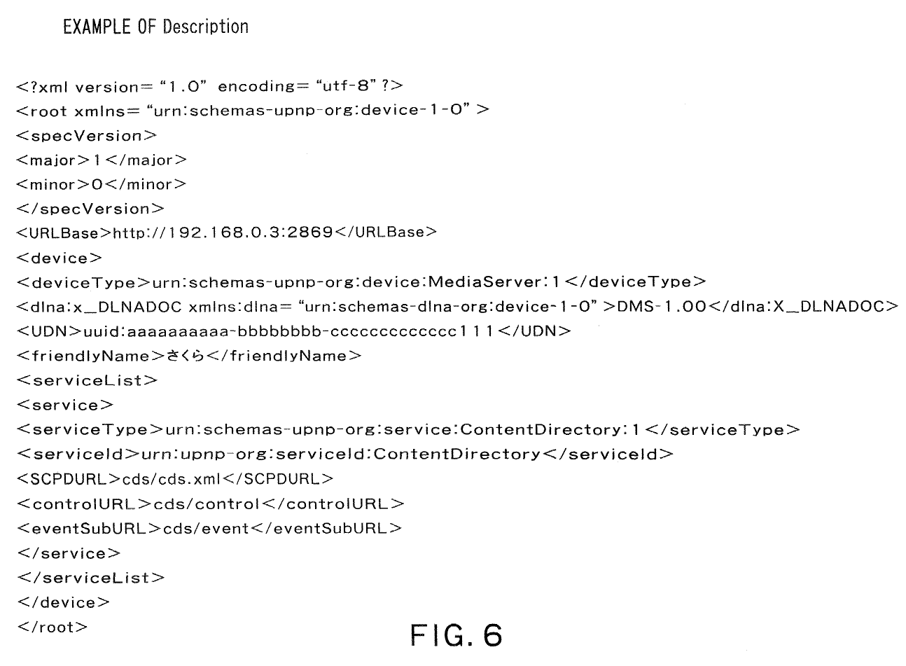

FIG. 6 shows an example of the Description document.

It is appreciated from a value of a <service Type> tag that the multimedia server 15 provides a Content Directory service.

It is appreciated from a value of a <URLBase> tag and a value of a <SCPDURL> tag that a Description document concerning the Content Directory service can be acquired by performing the HTTP GET on “http://192.168.0.3:2869/cds/cds.xml”.

It is appreciated from a value of a <URLBase> tag and a value of a <controlURL> tag that the Content Directory service can be accessed by performing HTTP Post of control data on “http://192.168.0.3:2869/cds/control”.

The NAT passage apparatus 17 transmits an open packet having, for example, (134.10.10.1, 192.168.0.3, 6, 10000, 2869) as (destination address, source address, protocol number, destination port number, and source port number) toward the computer 18 (Sl5). Here, 134.10.10.1 is an address of the computer 18, 192.168.0.3 is an address of the multimedia server 15, 6 is a protocol number representing a TCP, 10000 is a predetermined port number of the computer, and 2869 is a port number for accessing the multimedia server 15.

It is desirable that the open packet has a description of a service kind, authentication information of the NAT passage apparatus 17, and Description information.

As for the service kind, it is desirable that an identifier indicating that the found service device concerns a UPnP device is contained.

As for the authentication information, it is desirable that a sequence number of the open packet, an identifier of the NAT passage apparatus 17, an address of the NAT passage apparatus 17, and a hash value obtained from the sequence number, the identifier of the NAT passage apparatus 17, the address of the NAT passage apparatus 17 and the Description information are contained.

For calculating the hash value, it is desirable to further use a predetermined calculation algorithm and secret information preset in common to the NAT passage apparatus 17 and the computer 18.

The Description information has detailed description of contents of the found service. In the case of UPnP, a Description document received from the multimedia server 15 can be described.

When transferring an open packet, the NAT apparatus 13 performs translation of the source port and the source address. FIG. 2 shows the state of the Nat translation state table at that time.

In FIG. 2, a second entry corresponds to an open packet. The second entry indicates that the source address has been translated to 200.100.10.10 which is an address of the external network 12 side of the NAT apparatus 13 and the source port has been translated to 10002.

Upon receiving the open packet, the computer 18 confirms authentication information contained in the open packet, and confirms that this open packet is the proper packet from the NAT passage apparatus 17.

In addition, the computer 18 recognizes that service notified of by the open packet is Content Directory service of UPnP and recognizes a URL for accessing this service, on the basis of a service kind and Description information contained in the open packet.

In addition, the computer 18 knows that if a packet having (200.100.10.10, 134.10.10.1, 6, 10002, 10000) as (destination address, source address, protocol number, destination port number, and source port number) is transmitted the packet will arrive at the multimedia server 15 via the NAT apparatus 13, on the basis of an IP header and a TCP header contained in the open packet.

Upon receiving a contents browse request from, for example, the user via a mouse or keyboard, the computer 18 transmits an HTTP POST message (request packet) carrying a browse request according to Content Directory service specifications of UPnP (S16). The HTTP POST message has (200.100.10.10, 134.10.10.1, 6, 10002, 10000) as (destination address, source address, protocol number, destination port number, and source port number).

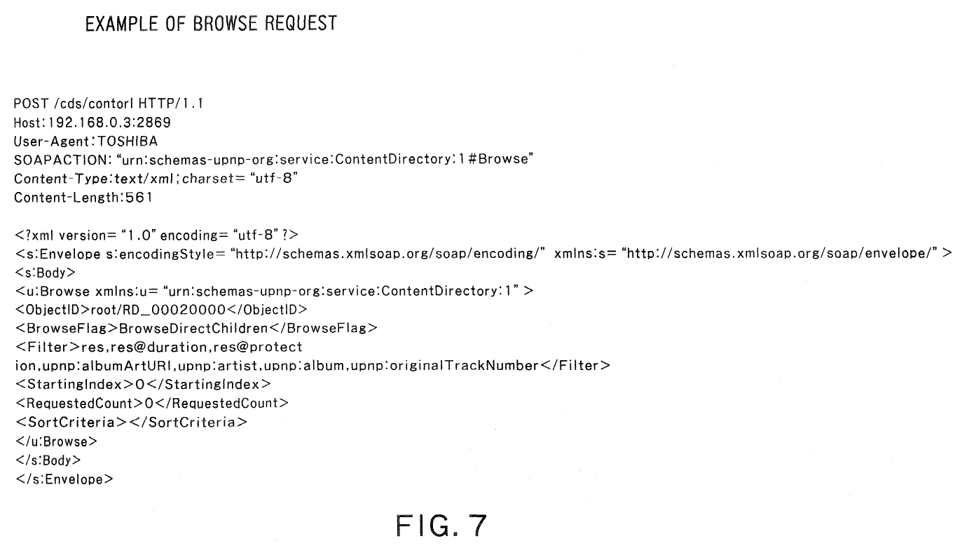

FIG. 7 shows an example of the browse request.

It is desirable to describe http://./cds/control or http://192.168.0.3:2869/cds/control in a POST URL in the HTTP POST message.

When this HTTP POST message passes through the NAT apparatus 13, (destination address, source address, protocol number, destination port number, and source port number) are translated to (192.168.0.3, 134.10.10.1, 6, 2869, 10000). A resultant message arrives at the multimedia server 15.

Upon receiving the HTTP POST message, the multimedia server 15 transmits a browse response message containing information of retained contents and a URL for accessing the contents toward the computer 18 as a response to the received message (S17).

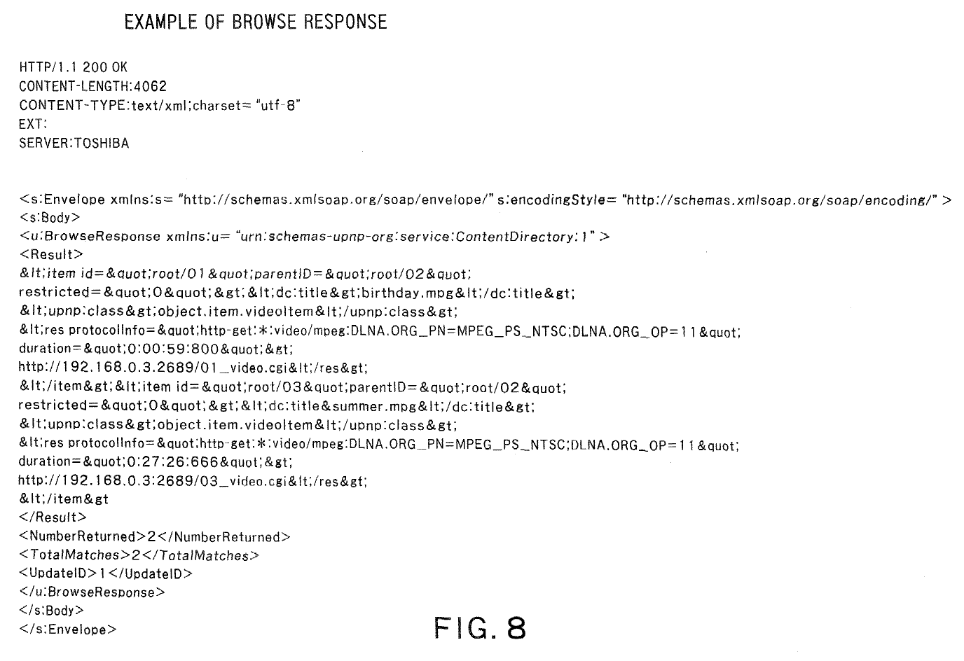

FIG. 8 shows an example of the browse response. In FIG. 8, the multimedia server 15 provides two contents having titles birthday.mpg and summer.mpg, and it is indicated that they can be accessed by using http://192.168.0.3:2689/01_video.cgi and http://192.168.0.3:2689/03_video.cgi, respectively.

Upon receiving the browse response message, the computer 18 stores the browse response message and displays contents titles contained therein on the screen. Upon receiving a contents reproduction request from, for example, the user via the keyboard or mouse, the computer 18 transmits an HTTP GET message (request packet) to an access URL of the contents (S18).

At this time, (destination address, source address, protocol number, destination port number, and source port number) are set to (200.100.10.10, 134.10.10.1, 6, 10002, 10000).

It is desirable to describe the URL received in the browse response, in a GET URL in the HTTP GET message at this time.

When this HTTP GET message passes through the NAT apparatus 13, (destination address, source address, protocol number, destination port number, and source port number) are translated to (192.168.0.3, 134.10.10.1, 6, 2869, 10000). A resultant message arrives at the multimedia server 15.

Upon receiving the HTTP GET message, the multimedia server 15 transmits contents, for example, moving picture data, corresponding to the GET URL toward the computer 18 as an HTTP GET response (S19).

In this way, an entry is created in the Nat translation state table in the NAT apparatus 13 in accordance with an open packet transmitted by the NAT passage apparatus 17. The computer 18 transmits a packet having a header corresponding to the entry. As a result, the computer 18 can perform communication with the multimedia server 15 via the NAT apparatus 13. Therefore, it becomes possible for the computer disposed on the external network side of the NAT apparatus 13 to utilize service provided by the multimedia server 15. (Utilization of persistent connection)

In the present embodiment, it is desirable in the case of HTTP in communication between the computer 18 and the multimedia server 15 to utilize a function called persistent connection in which a TCP connection is not disconnected every HTTP request/response. Owing to the persistent connection, it is possible to perform a procedure ranging, for example, from S13 to S19 by establishing a TCP connection once.

### (Bisecting Open Packet)

In the present embodiment, the open packet has a function of creating an entry in the Nat translation state table, and a function of conveying information concerning service provided by the home network 11 to the computer 18. It is also possible to separate the two functions into separate packets. This brings about an effect that the size of a packet transmitted periodically to maintain an entry in the Nat translation state table can be made small and traffic in the home network 11 and the external network 12 can be reduced. Hereafter, this will be described in more detail.

The NAT passage apparatus 17 may transmit a service notice packet (a second packet) when the NAT passage apparatus 17 has acquired the Description document.

It is desirable that the service notice packet has description of a service kind, authentication information of the NAT passage apparatus 17 and Description information. The header part of the service notice packet may have an address and a port number of the computer 18 as a destination address and a destination port number, and have an address and a port number of the NAT passage apparatus 17 as a source address and a source port number.

As for the service kind, it is desirable that an identifier indicating that the found service device concerns a UPnP device is contained.

As for the authentication information, it is desirable that a sequence number of the service notice packet, the identifier of the NAT passage apparatus 17, the address of the NAT passage apparatus 17, and a hash value obtained from the sequence number, the identifier of the NAT passage apparatus 17 and the address of the NAT passage apparatus 17 are contained. For calculating the hash value, it is desirable to further use a predetermined calculation algorithm and secret information preset in the NAT passage apparatus 17 and the computer 18.

The Description information has detailed description of contents of the found service. In the case of UPnP, a Description document received from the multimedia server 15 can be described.

In order to create an entry in the Nat translation state table, the NAT passage apparatus 17 transmits a Nat-translation-state-entry-generation-packet (a first packet). As for the Nat-translation-state-entry-generation-packet, a packet having (134.10.10.1, 192.168.0.3, 6, 10000, 2869) as (destination address, source address, protocol number, destination port number, and source port number) in the header is transmitted. This packet may be transmitted periodically.

It is desirable that flow information having values of a header part (header field) of the Nat-transiation-state-entry-generation-packet is described in a data part of the Nat-translation-state-entry-generation-packet. For example, as the flow information, (134.10.10.1, 192.168.0.3, 6, 10000, 2869) are described as (destination address, source address, protocol number, destination port number, and source port number) in the data part.

It is desirable that the Nat-translation-state-entry-generation-packet contains authentication information. In addition, it is desirable that the Nat-translation-state-entry-generation-packet contains information for association with the service notice packet, such as, for example, a UDN in Description information contained in the service notice packet. (Communication between NAT passage apparatus and computer through different connection)

The NAT passage apparatus 17 may establish a TCP connection for control, to the previously stored address and port number of the computer 18 at the time of start, and transmit a Nat-translation-state-entry-generation-packet when the NAT passage apparatus has received an address and a port number to be communicated with, from the computer 18. For this purpose, it is desirable that the NAT passage apparatus previously transmits a service notice packet to the computer 18.

To be more precise, the computer 18 transmits a Nat translation state entry generation request packet to the NAT passage apparatus 17 via a TCP connection for control. The data part in the Nat translation state entry generation request packet has description of (destination address, source address, protocol number, destination port number, and source port number) with which the computer 18 desires to communicate. For example, the data part has description of (192.168.0.3, 134.10.10.1, 6, 2869, 10000).

Upon receiving the Nat translation state entry generation request packet, the NAT passage apparatus 17 transmits a Nat-translation-state-entry-generation-packet toward the computer 18. In the header, (destination address, source address, protocol number, destination port number, and source port number) are (134.10.10.1, 192.168.0.3, 6, 10000, 2869). Furthermore, it is desirable that the Nat-translation-state-entry-generation-packet has header notice information that indicates that (destination address, source address, protocol number, destination port number, and source port number) are (134.10.10.1, 192.168.0.3, 6, 10000, 2869) in a data field other than the header.

The Nat-translation-state-entry-generation-packet may be transmitted periodically.

It is desirable to continue the periodic transmission of the Nat-translation-state-entry-generation-packet until a Nat translation state entry deletion request packet (stop request packet) which requests deletion of the entry from the Nat translation state table is received from the computer 18.

A data part in the Nat translation state entry deletion request packet has (destination address, source address, protocol number, destination port number, and source port number) of the communication which become unnecessary. For example, the dart part has description of (192.168.0.3, 134.10.10.1, 6, 2869, 10000).

The NAT passage apparatus 17 may transmit a service notice packet through the TCP connection for control. Preferably, the service notice packet is transmitted when the NAT passage apparatus 17 has received a Description document from the multimedia server 15.

### (Any Protocol can be used to Find Service)

In the present embodiment, the case where UPnP is used as the protocol for finding service is described. However, the effects of the present embodiment are not hampered even if another service finding protocol such as, for example, NETBIOS or SLP (Service Location Protocol) is used.

### (Finding Computer from Different Server)

In the present embodiment, the case where the NAT passage apparatus uses preset ones as the address and port of the computer is described. However, it is also possible for the NAT passage apparatus to have means for finding the computer by using a different method. For example, a directory server may be prepared in the external network 12. A computer that desires to access the home network 11 registers with the directory server, and the NAT passage apparatus finds an address and a port of the computer dynamically by accessing the directory server. For registering the computer with the directory server, various protocols such as SIP, XML/SOAP and dynamic DNS can be used.

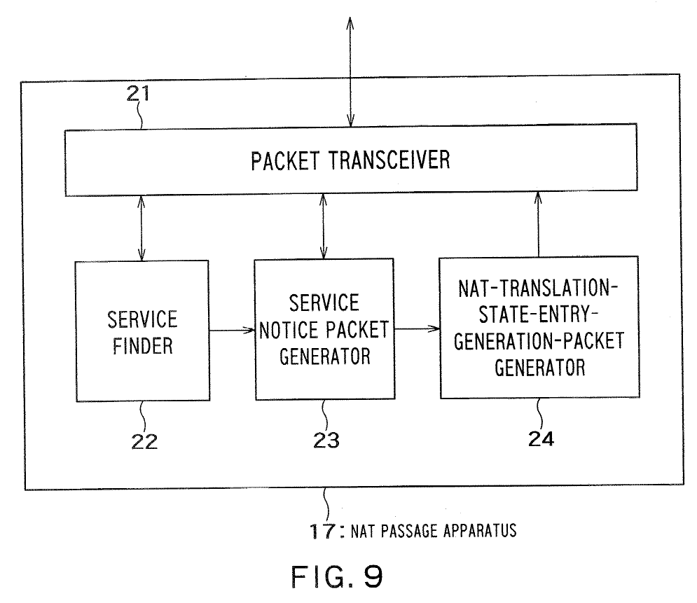

FIG. 9 is a diagram showing a configuration example of the NAT passage apparatus 17.

The NAT passage apparatus 17 includes a packet transceiver 21, a service finder 22, a service notice packet generator 23 and a Nat-translation-state-entry-generation-packet generator 24.

The packet transceiver 21 performs packet transmission and reception via a network interface.

The service finder 22 performs processing on service finding protocol via the packet transceiver 21. For example, if UPnP is used to find service, the service finder 22 transmits an SSDP search packet via the packet transceiver 21.

Upon receiving an SSDP search response packet or an SSDP alive packet via the packet transceiver 21, the service finder 22 transmits an HTTP GET request to a URL described in a LOCATION tag contained in the packet.

Upon receiving an HTTP GET response via the packet transceiver 21, the service finder 22 extracts a Description document contained in the HTTP GET response, and delivers values in the Description document to the service notice packet generator 23.

Whenever the service finder 22 receives the SSDP search response packet or the SSDP alive packet, the service finder 22 accesses the URL contained in the LOCATION tag. Instead, it is also possible to store uuid described on a USN tag and prevent access to a URL contained in a LOCATION tag in the case of an already accessed device.

Upon receiving a Description document from the service finder 22, the service notice packet generator 23 transmits a service notice packet toward the preset address and port number of the computer 18 in the external network 12. The service notice packet contains predetermined authentication information, a Description document received from the service finder 22 as Description information, and a service kind indicating that service notified of is UPnP.

Upon receiving a Nat translation state entry generation request packet from the computer 18, the service notice packet generator 23 extracts flow information contained in the packet, and delivers the extracted flow information to the Nat-translation-state-entry-generation-packet generator 24 as a NAT entry generation request.

In the flow information, (destination address, source address, protocol number, destination port number, and source port number) are described. For example, (192.168.0.3, 134.10.10.1, 6, 2869, 10000) are described.

Upon receiving a Nat translation state entry deletion request packet from the computer 18, the service notice packet generator 23 extracts flow information contained in the packet, and delivers the extracted flow information to the Nat-translation-state-entry-generation-packet generator 24 as a NAT entry deletion request.

In the flow information, (destination address, source address, protocol number, destination port number, and source port number) are described. For example, (192.168.0.3, 134.10.10.1, 6, 2869, 10000) are described.

Upon receiving a NAT entry generation request from the service notice packet generator 23, the Nat-translation-state-entry-generation-packet generator 24 starts periodic transmission of a Nat-translation-state-entry-generation-packet corresponding to flow information contained in the request.

The Nat-translation-state-entry-generation-packet has (source address, destination address, protocol number, source port number and destination port number) described in the flow information as (destination address, source address, protocol number, destination port number, and source port number) in its header part, and has authentication information of the NAT passage apparatus and flow information in its data part.

It is desirable that the authentication information of the NAT passage apparatus contains a sequence number of the Nat-transiation-state-entry-generation-packet, the identifier of the NAT passage apparatus, the address of the NAT passage apparatus, and a hash value obtained from the sequence number, the identifier of the NAT passage apparatus, the address of the NAT passage apparatus and the flow information.

Upon receiving a NAT entry deletion request from the service notice packet generator 23, the Nat-translation-state-entry-generation-packet generator 24 stops transmission of the Nat-translation-state-entry-generation-packet corresponding to flow information contained in the request

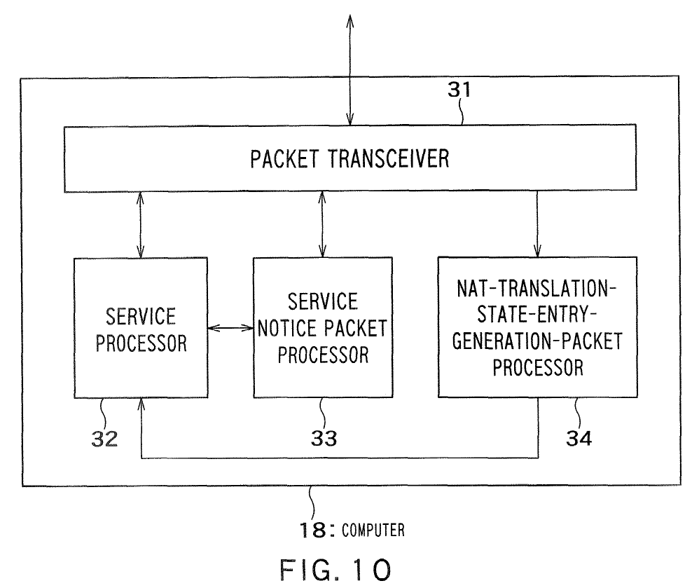

FIG. 10 is a diagram showing a configuration of the computer 18 disposed on the external network 12.

The computer 18 includes a packet transceiver 31, a service processor 32, a service notice packet processor 33, and a Nat-translation-state-entry-generation-packet processor 34.

The packet transceiver 31 performs packet transmission and reception via a network interface.

Upon receiving a service notice packet from the NAT passage apparatus 17 via the packet transceiver 31, the service notice packet processor 33 preferably confirms authentication information contained in the service notice packet. As for the confirmation of the authentication information, it is desirable to confirm that a sequence number contained in the authentication information is greater than a sequence number received from the NAT passage apparatus 17 having an identifier contained in the authentication information until then. In addition, it is desirable to calculate a hash value from the sequence number, the identifier of the NAT passage apparatus 17, the address of the NAT passage apparatus 17 and the Description information, and confirm that the calculated hash value is equal to a hash value contained in the authentication information.

Upon failing in the confirmation of the authentication information, the service notice packet processor 33 discards the received service notice packet.

Upon succeeding in the confirmation of the authentication information, the service notice packet processor 33 delivers Description information contained in the service notice packet to the service processor 32.

Upon receiving a NAT entry generation request from the service processor 32, the service notice packet processor 33 transmits a Nat translation state entry generation request packet carrying flow information contained in the NAT entry generation request to the NAT passage apparatus 17 via the packet transceiver 31.

(Destination address, source address, protocol number, destination port number, and source port number) in the header of the Nat translation state entry generation request packet are (source address, destination address, protocol number, source port number and destination port number) in the header of the service notice packet received from the NAT passage apparatus 17.

Upon receiving a NAT entry deletion request from the service processor 32, the service notice packet processor 33 transmits a Nat translation state entry deletion request packet carrying flow information contained in the NAT entry deletion request via the packet transceiver 31.

(Destination address, source address, protocol number, destination port number, and source port number) in the header of the Nat translation state entry deletion request packet are (source address, destination address, protocol number, source port number and destination port number) in the header of the service notice packet received from the NAT passage apparatus 17.

Upon receiving a Nat-translation-state-entry-generation-packet from the NAT passage apparatus 17, the Nat-translation-state-entry-generation-packet processor 34 notifies the service processor 32 of flow information contained in the Nat-translation-state-entry-generation-packet and header information in the Nat-translation-state-entry-generation-packet. It is desirable that the Nat-translation-state-entry-generation-packet processor 34 confirms authentication information in the Nat-translation-state-entry-generation-packet at this time.

As for the confirmation of the authentication information, it is desirable to confirm that a sequence number contained in the authentication information is greater than a sequence number received from the NAT passage apparatus having an identifier contained in the authentication information until then, and in addition, calculate a hash value from the sequence number, the identifier of the NAT passage apparatus, the address of the NAT passage apparatus and the flow information, and confirm that the calculated hash value is equal to a hash value contained in the authentication information.

Upon failing in the confirmation of the authentication information, it is desirable that the Nat-translation-state-entry-generation-packet processor 34 discards the Nat-translation-state-entry-generation-packet and the Nat-translation-state-entry-generation-packet processor 34 does not notify the service processor 32 of the flow information and header information

Upon receiving Description information from the service notice packet processor 33 and recognizing that service indicated in serviceid contained in the Description information is service to be processed by itself, the service processor 32 performs a Description document acquirement procedure on the basis of SCPDURL and URLBASE.

As for the Description document acquisition procedure, a URL for acquiring the Description document is first found, and in addition a NAT entry generation request is delivered to the service notice packet processor 33.

Subsequently, when the service processor 32 receives flow information and header information from the Nat-translation-state-entry-generation-packet processor 34, if the flow information indicates a flow to which a packet transmitted to acquire the Description document belongs, the service processor 32 transmits an HTTP GET request toward the URL for acquiring the Description document. At this time, (destination address, source address, protocol number, destination port number, and source port number) in the header of the IP packet are (source address, destination address, protocol number, source port number and destination port number) in the received header information.

### (Concrete Example of Description Document Acquisition Procedure)

For example, in the case where the service processor 32 has received the Description information shown in FIG. 6 from the service notice packet processor 33, a URL for acquiring a Description document is http://192.168.0.3:2689/cds/cs.xml, and as the flow information contained in the NAT entry generation request, (destination address, source address, protocol number, destination port number, and source port number) are (192.168.0.3, address of computer, 6, 2869, 10000). Here, 10000 is a port number used when the service processor 32 acquires the Description document.

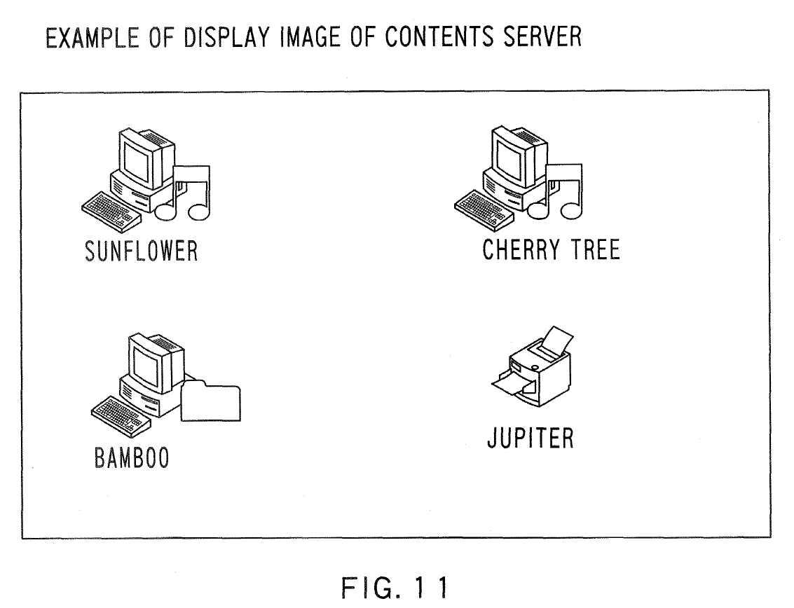

Upon acquiring the Description document, the service processor 32 displays icons which indicate found service devices on a display of itself. FIG. 11 is an example of the display screen. The service processor 32 includes, for example, exhibiter exhibiting the icons.

The user selects an icon by using a keyboard or mouse. Upon receiving a selection signal from the user, the service processor 32 transmits, for example, a browse request.

At this time, (source address, destination address, protocol number, source port number and destination port number) in the received header information are stored in (destination address, source address, protocol number, destination port number, and source port number) in the header of the IP packet.

Upon receiving a browse response, it is desirable that the service processor 32 displays a list of contents titles contained in the browse response on the display of itself. For example, if the browse response shown in FIG. 8 is received, the service processor 32 displays icons containing character strings “birthday” and “summer” on the display.

The user selects an icon by using the keyboard or mouse. Upon receiving the selection signal, the service processor 32 transmits an HTTP GET request to a URL described in a <res> tag in the browse response. For example, it is desirable that its HTTP header contains the following lines.
GET/01_video.cgi
HOST: 192.168.0.3:2689
   Furthermore, (source address, destination address, protocol number, source port number and destination port number) in the received header information are stored in (destination address, source address, protocol number, destination port number, and source port number) in the header of the packet.

Since the service processor 32 receives, for example, moving picture data and music data, these data are output to a display and a speaker included in the computer 18 as the response.

Owing to such cooperative operation performed between the computer 18 disposed on the external network 12 and the NAT passage apparatus 17, it becomes possible for the computer 18 to utilize service provided by service devices disposed on the home network 11 via the NAT apparatus 13.

The home network 11 and the external network 12 mean two networks connected by the NAT apparatus. For example, these networks 11 and 12 are an intra-network and the Internet, and even in this case, effects of the present embodiment are not diminished.

In the present embodiment, the NAT passage apparatus 17 has a function of passing through packets from the external network 12, if the communication is started from the home network 11, and a function of preventing packets from the external network 12 from being passed through otherwise. As long as an apparatus has such a function, an apparatus that does not rewrite the packet address, such as a firewall apparatus, may also be used.

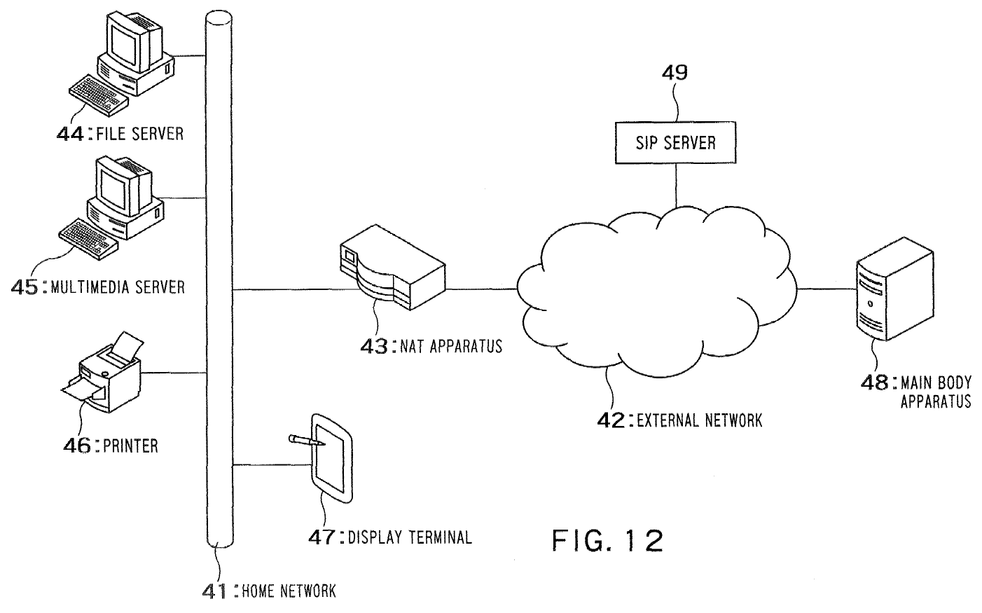

FIG. 12 is a diagram showing a typical configuration of a second embodiment according to the present invention.

A home network 41 and an external network 42 are connected to each other by a NAT apparatus 43. A file server 44, a multimedia server 45, a printer 46 and a display terminal (NAT passage apparatus) 47 are connected to the home network 41. A main body apparatus (information processing server) 48 and a SIP server (information management server) 49 are connected to the external network 42. The display terminal 47 is controlled by the user.

Since operation of the NAT apparatus 43, operation of the file server 44, operation of the multimedia server 45, operation of the printer 46, and service finding operation are the same as those in the first embodiment, detailed description of them will be omitted.

The display terminal 47 is connected to the main body apparatus 48, for example, at a time of start-up by using an address and a port number preset as a destination address and a destination port number.

The display terminal 47 receives output data from the main body apparatus 48. The display terminal 47 receives, for example, a screen signal and a voice signal as an MPEG2 stream by using, for example, RTP or HTTP. The display terminal 47 displays image data contained in the output data (for example, an MPEG2 stream) on a screen of itself, and outputs voice data contained in the output data from a speaker of itself.

Furthermore, the display terminal 47 transmits input data input from a keyboard, a mouse or a microphone to the main body apparatus 48. The main body apparatus 48 performs processing on received input data, and transmits output data corresponding thereto to the display terminal 47.

The display terminal 47 finds a device that provides service, by receiving an advertisement packet using NETBIOS, UPnP or another protocol, and stores an address and a port number contained in the advertisement packet.

The display terminal 47 transmits an open packet toward an address and a port number of the main body apparatus 48 stored previously. At this time, a source address and a source port number of the open packet are provided with the same values as those of the address and port number contained in the advertisement packet. The display terminal 47 may prevent an entry from being deleted from the Nat translation state table in the NAT apparatus 43 by transmitting this open packet periodically.

The main body apparatus 48 disposed on the external network 42 knows that a service device is present in the home network 41 by receiving the open packet.

The main body apparatus 48 transmits a packet having (source address, destination address, protocol number, source port number and destination port number) of the received open packet as (destination address, source address, protocol number, destination port number, and source port number). As a result, it becomes possible for the main body apparatus 48 to access the desired server.

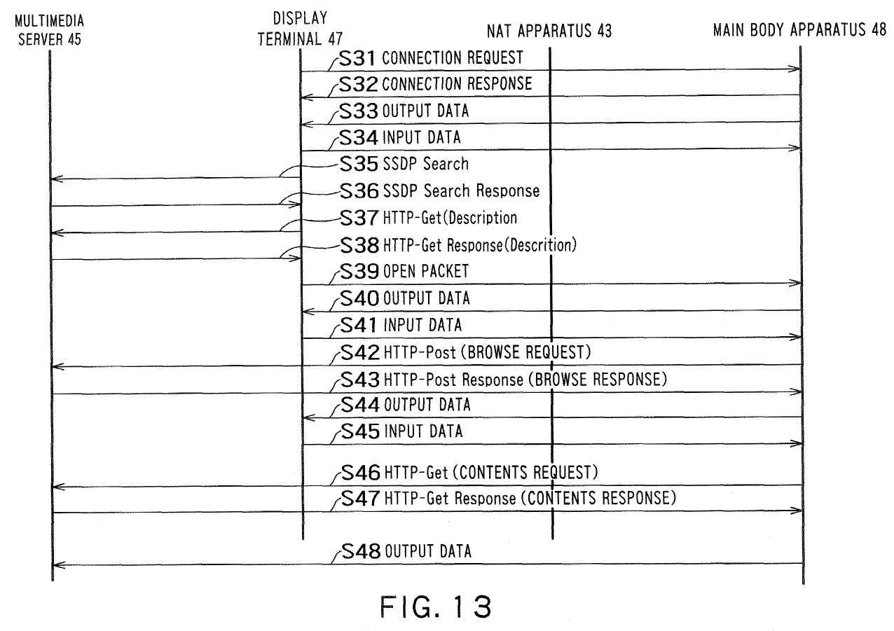

FIG. 13 shows an example of a communication sequence according to the present embodiment.

The display terminal 47 transmits a connection request toward a predetermined address and port number of the main body apparatus 48 (S31). The connection request contains authentication information and a control kind. The control kind has description of a value meaning that this packet is a connection request.

As for the authentication information, it is desirable that a sequence number of the connection request, an identifier of the display terminal, an address of the display terminal, and a hash value are contained. For calculating the hash value, it is desirable to use a predetermined calculation algorithm, secret information preset in common to the display terminal and the computer, the sequence number in the connection request, the identifier of the display terminal, and the address of the display terminal.

Upon receiving the connection request, the main body apparatus 48 confirms the authentication information contained in the connection request. If the authentication information is proper, the main body apparatus transmits a connection response (S32). The connection response contains the control kind, and has description of a value to the effect that the connection is permitted. If the authentication information is judged to be illegal, the main body apparatus 48 discards the received connection request. If the connection request is transmitted by using TCP, it is desirable to disconnect the TCP connection.

As for the confirmation of the authentication information, it is desirable to confirm that a hash value calculated on the basis of a predetermined calculation algorithm, secret information shared previously with the display terminal, the sequence number in the connection request, the identifier of the display terminal and the address of the display terminal is equal to a hash value in the connection request.

If the authentication information is proper, the main body apparatus 48 loads a computer state for the display terminal 47 (for example, an initial state prepared previously for the computer) from a storage included in itself, and transmits screen information and voice information corresponding to the state as output data (S33). As for the transmission of the output data, it is desirable to transmit the output data by using the same TCP connection as that of the connection request.

Upon receiving the connection response, the display terminal 47 displays received output data and transmits input data input by the user (S34).

Since S35 to S39 are the same as Sll to S15 shown in FIG. 3, detailed description will be omitted.

The main body apparatus 48 confirms authentication information contained in an open packet received at S39.

In addition, the main body apparatus 48 recognizes that service notified of by the open packet is Content Directory service of UPnP and recognizes a URL for accessing this service, on the basis of a service kind and Description information contained in the open packet.

In addition, the main body apparatus 48 knows that if a packet having (200.100.10.10, 134.10.10.1, 6, 10002, 10000) as (destination address, source address, protocol number, destination port number, and source port number) is transmitted the packet will arrive at the multimedia server 45 via the NAT apparatus 43, on the basis of an IP header and a TCP header contained in the open packet.

The main body apparatus 48 knows the Content Directory service of UPnP from the Description information in the open packet, and transmits output data containing screen data indicating that appearance of the Content Directory service has been detected, to the display terminal 47 (S40).

The display terminal 47 displays image data (icons) contained in the output data on a display of itself. The display terminal 47 includes an exhibitor exhibiting the image data. FIG. 11 shows an example of this display. In FIG. 11, it is indicated that “sunflower,” “cherry tree,” and “bamboo” have been found as devices that are providing Content Directory service of UPnP and “Jupiter” has been found as a device that is providing printer service.

If an icon on the screen is selected by the user touching the keyboard, mouse or display, the display terminal 47 transmits input data (service start packet) carrying the selected event to the main body apparatus 48 (S41).

Upon receiving the input data carrying the selected event, the main body apparatus 48 transmits an HTTP POST message (request packet) carrying a browse request according to Content Directory service specifications of UPnP. The HTTP POST message has (200.100.10.10, 134.10.10.1, 6, 10002, 10000) as (destination address, source address, protocol number, destination port number, and source port number) (S42). FIG. 7 shows an example of the browse request.

It is desirable to describe http://./cds/control or http://192.168.0.3:2869/cds/control as a POST URL in the HTTP POST message at this time.

When this HUTP POST message passes through the NAT apparatus 43, (destination address, source address, protocol number, destination port number, and source port number) are translated to (192.168.0.3, 134.10.10.1, 6, 2869, 10000). A resultant message arrives at the multimedia server 45.

Upon receiving the HTTP POST message, the multimedia server 45 transmits a browse response message containing retained contents and a URL for accessing the contents toward the main body apparatus 48 as a response to the received message (S43).

FIG. 8 shows an example of the browse response. In FIG. 8, two contents having titles birthday.mpg and summer.mpg are provided, and it is indicated that they can be accessed by using http://192.168.0.3:2689/01_video.cgi and http://192.168.0.3:2689/03_video.cgi, respectively.

Upon receiving the browse response message, the main body apparatus 48 stores the browse response message and transmits screen display data of the contents titles contained in the browse response message to the display terminal 47 as output data (S44).

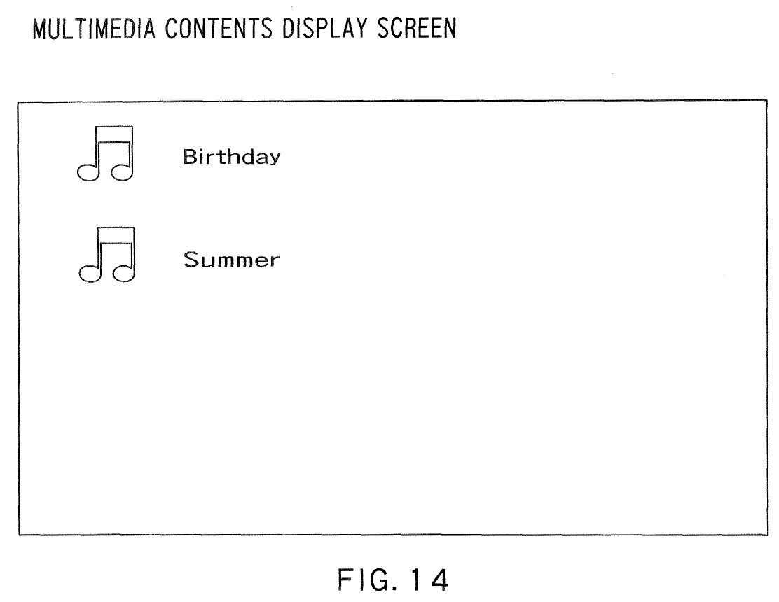

The display terminal 47 displays received output data on the screen. An example of the output screen is shown in FIG. 14. In FIG. 14, it indicated that two multimedia data “Birthday” and “Summer” are present on the multimedia server 45.

Upon receiving an event (service request packet) in which multimedia data has been selected by, for example, the user using the keyboard, mouse or touch panel, the display terminal 47 transmits the event to the main body apparatus 48 as input data.

Upon receiving input data from the display terminal 47, the main body apparatus 48 transmits an HTTP GET message (request packet) to an access URL of the selected contents (S46).

At this time, the main body apparatus 48 transmits a packet having (200.100.10.10, 134.10.10.1, 6, 10002, 10000) as (destination address, source address, protocol number, destination port number, and source port number).

It is desirable to describe the URL received in the browse response, in a GET URL in the HTTP GET message at this time.

When this HTTP GET message passes through the NAT apparatus 43, (destination address, source address, protocol number, destination port number, and source port number) are translated to (192.168.0.3, 134.10.10.1, 6, 2869, 10000). A resultant message arrives at the multimedia server 45.

Upon receiving the HTTP GET message, the multimedia server 45 transmits contents, for example, moving picture data, corresponding to the GET URL toward the main body apparatus 48 as an HTTP GET response (S47).

In this way, an entry is created in the Nat translation state table in the NAT apparatus 43 in accordance with an open packet transmitted by the display terminal 47. The main body apparatus 48 transmits a packet having a header corresponding to the entry. As a result, the main body apparatus 48 can perform communication with the multimedia server 45 via the NAT apparatus 43. Therefore, it becomes possible for the main body apparatus 48 disposed on the external network 42 to utilize service provided by the multimedia server 45.

Upon receiving data of multimedia contents from the multimedia server 45 at S47, the main body apparatus 48 decodes the data of the multimedia contents and transmits resultant data to the display terminal 47 as output data (S48).

The display terminal 47 outputs image data and voice data contained in the output data to the display or speaker.

Thus, in a system in which the main body apparatus and the display terminal operate cooperatively, it becomes possible for the display terminal to use service found by itself, via the main body apparatus.

### (Utilization of Persistent Connection)

In the present embodiment, it is desirable in the case of HTTP in communication between the main body apparatus 48 and the multimedia server 45 to utilize a function called persistent connection in which a TCP connection is not disconnected every HTTP request/response.

### (Bisecting Open Packet)

In the present embodiment, the open packet has a function of creating an entry in the Nat translation state table, and a function of conveying information concerning service provided by the home network to the main body apparatus 48. It is also possible to separate the two functions into separate packets (service notice packet and Nat-translation-state-entry-generation-packet). Hereafter, this will be described in more detail.

The display terminal 47 may transmit a service notice packet when the display terminal 47 has acquired the Description document. It is desirable that the service notice has description of a service kind, authentication information of the display terminal and Description information.

As for the service kind, it is desirable that an identifier indicating that the found service device concerns a UPnP device is contained.

As for the authentication information, it is desirable that a sequence number of the service notice packet, the identifier of the display terminal, the address of the display terminal, and a hash value obtained from the sequence number, the identifier of the display terminal, the address of the display terminal, and Description information are contained. For calculating the hash value, it is desirable to use a predetermined calculation algorithm and secret information preset in common to the display terminal and the main body apparatus.

The Description information has detailed description of contents of the found service. In the case of UPnP, a Description document received from the multimedia server can be described.

In order to create an entry in the Nat translation state table, the display terminal 47 transmits a Nat-translation-state-entry-generation-packet The header in the Nat-translation-state-entry-generation-packet has (134.10.10.1, 192.168.0.3, 6, 10000, 2869) as (destination address, source address, protocol number, destination port number, and source port number).

This packet may be transmitted periodically.

It is desirable that flow information having values of a header part of the Nat-translation-state-entry-generation-packet described therein is described in a data part of the Nat-translation-state-entry-generation-packet. For example, as the flow information, (134.10.10.1, 192.168.0.3, 6, 10000, 2869) are described as (destination address, source address, protocol number, destination port number, and source port number).

It is desirable that the Nat-translation-state-entry-generation-packet contains authentication information. In addition, it is desirable that the Nat-translation-state-entry-generation-packet contains information for association with the service notice packet, such as, for example, a UDN in Description information contained in the service notice packet.

### (Communication Between Display Terminal and Main Body Apparatus through Different Connection)

The display terminal 47 may establish a TCP connection for control, to the previously stored address and port number of the main body apparatus 48 at the time of start-up, and transmit a Nat-translation-state-entry-generation-packet when the display terminal 47 has received from the main body apparatus 48 an address and a port number to which the main body apparatus 48 desires to communicate. The main body apparatus 48 transmits a Nat translation state entry generation request packet to the display terminal 47 via a TCP connection for control. The Nat translation state entry generation request packet has description of (destination address, source address, protocol number, destination port number, and source port number) with which the main body apparatus 48 desires to communicate. For example, the Nat translation state entry generation request packet has description of (192.168.0.3, 134.10.10.1, 6, 2869, 10000).

Upon receiving the Nat translation state entry generation request packet, the display terminal 47 transmits a Nat-translation-state-entry-generation-packet to the main body apparatus 48. In the header, (destination address, source address, protocol number, destination port number, and source port number) are (134.10.10.1, 192.168.0.3, 6, 10000, 2869). Furthermore, it is desirable that the Nat-translation-state-entry-generation-packet has header notice information that indicates that (destination address, source address, protocol number, destination port number, and source port number) are (134.10.10.1, 192.168.0.3, 6, 10000, 2869) in a data field other than the header.

The Nat-translation-state-entry-generation-packet may be transmitted periodically.

It is desirable to continue the periodic transmission of the Nat-translation-state-entry-generation-packet until a Nat translation state entry deletion request packet is received from the main body apparatus 48.

The Nat translation state entry deletion request packet has (destination address, source address, protocol number, destination port number, and source port number) of communication which has become unnecessary. For example, (192.168.0.3, 134.10.10.1, 6, 2869, 10000) is described.

The display terminal 47 may transmit a service notice packet through the TCP connection for control. Preferably, the display terminal 47 transmits the service notice packet when the display terminal 47 has received a Description document from the multimedia server 45.

### (Any Protocol can be used to Find Service)

In the present embodiment, the case where UPnP is used as the protocol for finding service is described. However, the effects of the present embodiment are not hampered even if another service finding protocol such as, for example, NETBIOS or SLP (Service Location Protocol) is used.

### (Finding Computer from Different Server)

In the present embodiment, the case where the display terminal uses preset ones as the address and port of the computer is described. However, it is also possible for the display terminal to have means for finding the main body apparatus by using a different method. For example, the main body apparatus previously registers the address, port number and SIP URI of itself with the SIP server 49 (see FIG. 12) by using a REGISTER message of SIP, and the display terminal previously retains a SIP URI of the main body apparatus. The display terminal can find the address and port number of the main body apparatus by transmitting an INVITE message directed to the SIP URI to a predetermined SIP server or a SIP server that manages the home network.

In this case, it becomes unnecessary for the main body apparatus to be associated with the display terminal in one-to-one correspondence, and it is also possible for the display terminal to use a proper SIP URI according to found service. It is also possible to prepare a plurality of main body apparatuses for a single SIP URI as well and use a proper main body apparatus according to the network situation such as the load of the display terminal and main body apparatus and the route length. Or it is also possible to previously store SIP URIs respectively corresponding to a plurality of main body apparatuses in a terminal apparatus and use a main body apparatus to be used, properly according to user's selection.

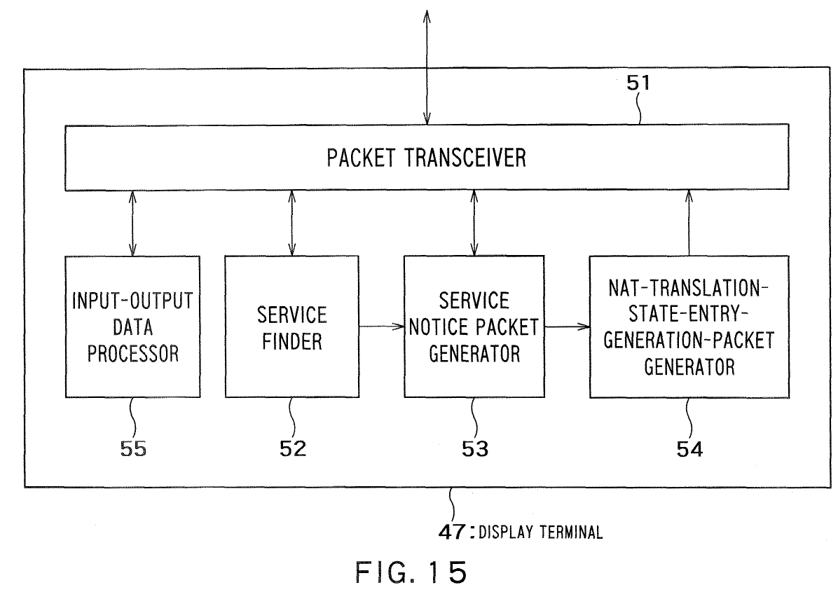

FIG. 15 is a diagram showing a configuration example of the display terminal 47.

The display terminal 47 includes a packet transceiver 51, a service finder 52, a service notice packet generator 53, a Nat-translation-state-entry-generation-packet generator 54, and an input-output data processor 55.

The packet transceiver 51 performs packet transmission and reception via a network interface.

The service finder 52 performs processing on service finding protocol via the packet transceiver 51. For example, if UPnP is used to find service, the service finder 52 transmits an SSDP search packet via the packet transceiver 51.

Upon receiving an SSDP search response packet or an SSDP alive packet via the packet transceiver 51, the service finder 52 transmits an HTTP GET request to a URL described in a LOCATION tag contained in the packet.

Upon receiving an HTTP GET response via the packet transceiver 51, the service finder 52 extracts a Description document contained in the HTTP GET response, and transmits values in the Description document to the service notice packet generator 53.

Whenever the service finder 52 receives the SSDP search response packet or the SSDP alive packet, the service finder 52 accesses the URL contained in the LOCATION tag. Instead, it is also possible to store uuid described on a USN tag and prevent access to a URL contained in a LOCATION tag in the case of an already accessed device.

Upon receiving a Description document from the service finder 52, the service notice packet generator 53 transmits a service notice packet toward the preset address and port number of the main body apparatus 48. The service notice packet contains predetermined authentication information, a Description document received from the service finder 52 as Description information, and a service kind indicating that service notified of is UPnP.

Upon receiving a Nat translation state entry generation request packet from the main body apparatus 48, the service notice packet generator 53 delivers flow information contained in the packet to the Nat-translation-state-entry-generation-packet generator 54 as a NAT entry generation request.

In the flow information, (destination address, source address, protocol number, destination port number, and source port number) are described. For example, (192.168.0.3, 134.10.10.1, 6, 2869, 10000) are described.

Upon receiving a Nat translation state entry deletion request packet from the main body apparatus 48, the service notice packet generator 53 extracts flow information contained in the packet, and delivers the extracted flow information to the Nat-translation-state-entry-generation-packet generator 54 as a NAT entry deletion request.

In the flow information, (destination address, source address, protocol number, destination port number, and source port number) are described. For example, (192.168.0.3, 134.10.10.1, 6, 2869, 10000) are described.

Upon receiving a NAT entry generation request from the service notice packet generator 53, the Nat-translation-state-entry-generation-packet generator 54 starts periodic transmission of a Nat-translation-state-entry-generation-packet corresponding to flow information contained in the request.

The Nat-translation-state-entry-generation-packet has (source address, destination address, protocol number, source port number and destination port number) described in the flow information as (destination address, source address, protocol number, destination port number, and source port number) in its header part, and has authentication information of the display terminal and flow information in its data part.

It is desirable that the authentication information of the display terminal contains a sequence number of the Nat-translation-state-entry-generation-packet, the identifier of the display terminal, the address of the display terminal, and a hash value obtained from the sequence number, the identifier of the display terminal, the address of the display terminal and the flow information.

Upon receiving a NAT entry deletion request from the service notice packet generator 53, the Nat-translation-state-entry-generation-packet generator 54 stops transmission of the Nat-translation-state-entry-generation-packet corresponding to flow information contained in the request.

The input-output data processor 55 transmits a connection request toward a predetermined address and port number of the main body apparatus 48 at the time of, for example, start-up. The connection request contains authentication information and a control kind.

The control kind has description of a value meaning that this packet is a connection request.

As for the authentication information, it is desirable that a sequence number of the connection request, an identifier of the display terminal, an address of the display terminal, and a hash value are contained. For calculating the hash value, it is desirable to use a predetermined calculation algorithm, secret information preset in common to the display terminal and the main body apparatus, the sequence number in the connection request, the identifier of the display terminal, and the address of the display terminal.

Upon receiving connection confirmation from the main body apparatus 48, the input-output data processor 55 starts reception of output data from the main body apparatus 48 and transmission of input data to the main body apparatus 48.

Upon receiving the output data from the main body apparatus 48, the input-output data processor 55 outputs image data or voice data contained in the output data to the display or speaker. Upon receiving an input event from the keyboard, mouse or touch panel, the input-output data processor 55 transmits the input event to the main body apparatus 48 as input data.

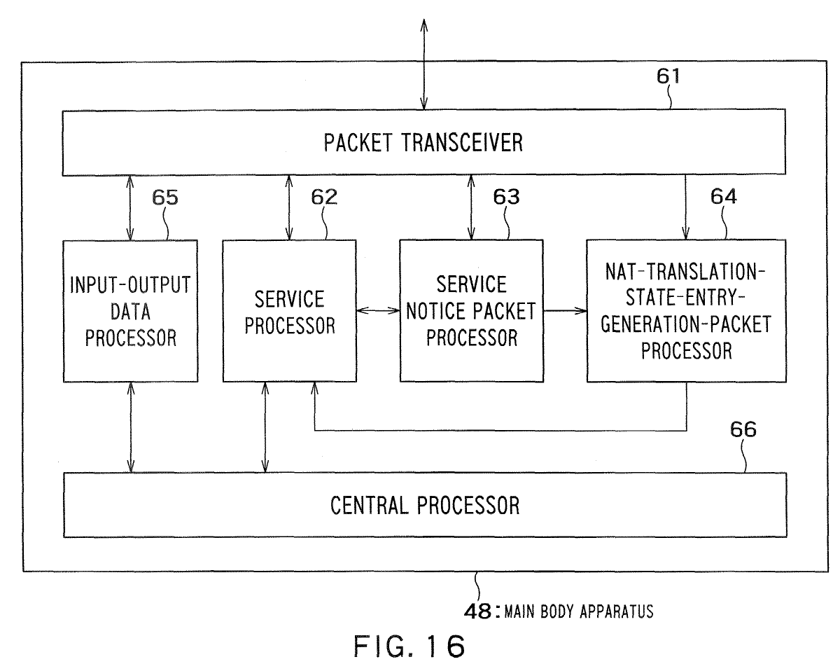

FIG. 16 is a diagram showing a configuration of the main body apparatus 48 disposed on the external network 42.

The main body apparatus 48 includes a packet transceiver 61, a service processor 62, a service notice packet processor 63, a Nat-translation-state-entry-generation-packet processor 64, an input-output data processor 65 and a central processor 66.

The packet transceiver 61 performs packet transmission and reception via a network interface.

Upon receiving the connection request, the input-output data processor 65 confirms the authentication information contained in the connection request. If the authentication information is proper, the input-output data processor 65 transmits a connection response. The connection response contains the control kind, and has description of a value to the effect that the connection is permitted. If the authentication information is judged to be illegal, the input-output data processor 65 discards the received connection request. If the connection request is transmitted by using TCP, it is desirable to disconnect the TCP connection.

As for the confirmation of the authentication information, it is desirable to confirm that a hash value calculated on the basis of a predetermined calculation algorithm, secret information shared previously with the display terminal, the sequence number in the connection request, the identifier of the display terminal and the address of the display terminal is equal to a hash value in the connection request.

If the authentication information is proper, the input-output data processor 65 delivers connection information to the central processor 66. It is desirable that the connection information contains the identifier of the display terminal.

The input-output data processor 65 transmits screen data or music data received from the central processor 66 to the display terminal via the packet transceiver 61 as output data. It is desirable that the input-output data processor 65 converts the output data to a suitable format such as MPEG2 on HTTP at this time. The input-output data processor 65 delivers input data supplied from the display terminal to the central processor 66.

The service notice packet processor 63 receives a service notice packet from the display terminal via the packet transceiver 61. It is desirable that the service notice packet processor 63 confirms authentication information contained in the service notice packet. As for the confirmation of the authentication information, it is desirable to confirm that a sequence number contained in the authentication information is greater than a sequence number received from the display terminal having an identifier contained in the authentication information until then. In addition, it is desirable to calculate a hash value from the identifier of the display terminal, the address of the display terminal, the sequence number and the Description information, and confirm that the calculated hash value is equal to a hash value contained in the authentication information.

Upon failing in the confirmation of the authentication information, the service notice packet processor 63 discards the received service notice packet. Upon succeeding in the confirmation of the authentication information, the service notice packet processor 63 delivers Description information contained in the service notice packet to the service processor 62.

Upon receiving a NAT entry generation request from the service processor 62, the service notice packet processor 63 transmits a Nat translation state entry generation request packet carrying flow information contained in the NAT entry generation request via the packet transceiver 61.

(Destination address, source address, protocol number, destination port number, and source port number) in the header of the Nat translation state entry generation request packet are (source address, destination address, protocol number, source port number and destination port number) in the header of the service notice packet received from the display terminal Upon receiving a NAT entry deletion request from the service processor 62, the service notice packet processor 63 transmits a Nat translation state entry deletion request packet carrying flow information contained in the NAT entry deletion request via the packet transceiver 61.

(Destination address, source address, protocol number, destination port number, and source port number) in the header of the Nat translation state entry deletion packet are (source address, destination address, protocol number, source port number and destination port number) in the header of the service notice packet received from the display terminal.

Upon receiving a Nat-translation-state-entry-generation-packet from the display terminal, the Nat-translation-state-entry-generation-packet processor 64 delivers flow information contained in the Nat-translation-state-entry-generation-packet and header information in the Nat-transiation-state-entry-generation-packet to the service processor 62. It is desirable that the Nat-translation-state-entry-generation-packet processor 64 confirms authentication information in the Nat-translation-state-entry-generation-packet at this time.

As for the confirmation of the authentication information, it is desirable to confirm that a sequence number contained in the authentication information is greater than a sequence number received from the display terminal having an identifier contained in the authentication information until then, and in addition, calculate a hash value from the identifier of the display terminal, the address of the display terminal, the sequence number and the flow information, and confirm that the calculated hash value is equal to a hash value contained in the authentication information.

Upon failing in the confirmation of the authentication information, it is desirable that the Nat-translation-state-entry-generation-packet processor 64 discards the Nat-translation-state-entry-generation-packet and the Nat-translation-state-entry-generation-packet processor 64 does not deliver the flow information and header information to the service processor 62.

Upon receiving Description information from the service notice packet processor 63 and recognizing that service indicated in serviceid contained in the Description information is service to be processed by itself, the service processor 62 performs a Description document acquirement procedure on the basis of SCPDURL and URLBASE.

As for the Description document acquisition procedure, at first, the service processor 62 finds a URL for acquiring the Description document, and in addition, delivers a NAT entry generation request which is required to acquire the Description document to the service notice packet processor 63.

Subsequently, when the service processor 62 receives flow information and header information from the Nat-translation-state-entry-generation-packet processor 64, if the flow information indicates a flow to which a packet transmitted to acquire the Description document belongs, the service processor 62 transmits an HTTP GET request toward the URL for acquiring the Description document. At this time, (destination address, source address, protocol number, destination port number, and source port number) in the header of the IP packet are (source address, destination address, protocol number, source port number and destination port number) in the received header information.

### (Concrete Example of Description Document Acquisition Procedure)

For example, in the case where the service processor 62 has received the Description information shown in FIG. 6 from the service notice packet processor 63, a URL for acquiring a Description document is http://192.168.0.3:2689/cds/cs.xml, and the flow information contained in the NAT entry generation request has (192.168.0.3, address of the main body apparatus, 6, 2869, 10000) as (destination address, source address, protocol number, destination port number, and source port number).

Here, 10000 is a port number used when the service processor 62 acquires the Description document.

Upon acquiring the Description document, the service processor 62 delivers it to the central processor 66. Upon receiving a browse transmission request from the central processor 66, the service processor 62 transmits a browse request packet.

At this time, (destination address, source address, protocol number, destination port number, and source port number) in the header of the IP packet are (source address, destination address, protocol number, source port number and destination port number) in the received header information.

Upon receiving a browse response, the service processor 62 delivers contents of the browse response to the central processor 66.

The service processor 62 transmits an HTTP GET request to a URL described in a <res> tag in the browse response. For example, it is desirable that its HTTP header contains the following lines.
GET/01-video.cgi
HOST: 192.168.0.3:2689

Furthermore, (destination address, source address, protocol number, destination port number, and source port number) in the header of the packet are (source address, destination address, protocol number, source port number and destination port number) in the received header information.

Since the service processor 62 receives, for example, moving picture data as the response, the service processor 62 delivers it to the central processor 66.

The central processor 66 is performing operation processing of an OS or an application program in the main body apparatus. The central processor 66 performs reception and transmission of input data and output data with the display terminal via the input-output data processor 65. The output data is image data or voice data to be displayed on the display terminal, and the input data is an input event from the keyboard, mouse, or touch panel on the display terminal. As a result, it becomes possible for the display terminal to function as if it is coupled directly to the main body apparatus.

Upon receiving the above-described connection information from the input-output data processor 65, the central processor 66 preferably loads a computer state for the display terminal corresponding to an identifier contained in the connection information and transmits screen information and voice information corresponding to the state to the display terminal as output data.

Upon receiving the Description document from the service processor 62, the central processor 66 creates image data that indicates a friendly Name of a device contained in the Description document and an icon indicating that the device is a device providing Contents Directory Service. If there are different devices already found until then, however, it is desirable the generated image data contains icons of these devices as well. The central processor 66 transmits the created image data to the display terminal via the input-output data processor 65. FIG. 11 is an example of the display screen.

Upon receiving input data meaning that an icon has been selected from the display terminal, the central processor 66 delivers a browse transmission request for a device corresponding to the selected icon to the service processor 62.

Upon receiving a browse response from the service processor 62, the central processor 66 generates screen data to display titles of contents contained in the browse response as a list, and transmits the generated screen data to the display terminal via the input-output data processor 65.

Upon receiving input data meaning that contents have been selected from the display terminal, the central processor 66 transmits a contents acquisition request for the selected contents.

Upon receiving, for example, moving picture data from the service processor 62 as a response to the contents acquisition request, the central processor 66 decodes the moving picture data and transmits resultant data to the display terminal via the input-output data processor 65.

Owing to such cooperative operation performed between the main body apparatus disposed on the external network and the display terminal disposed on the home network, it becomes possible for the main body apparatus disposed on the external network to utilize service provided by service devices disposed on the home network via the NAT apparatus.

The home network and the external network mean two networks connected by the NAT apparatus. For example, these two networks may be an intra-network and the Internet, and even in this case, effects of the present embodiment are not diminished.

In the present embodiment, the NAT apparatus has a function of passing through packets from the external network, if the communication is started from the home network, and a function of preventing packets from the external network from being passed through otherwise. As long as having such a function, an apparatus that does not rewrite the packet address, such as a firewall apparatus, may also be used.

In the present embodiment, operation has been described by taking the case where moving picture data is acquired from the multimedia server as an example. The present embodiment can also be applied to the case where the server provides data other than moving pictures, such as still pictures or voice data Furthermore, the present embodiment can also be applied to the case where the server is, for example, a file server or a printer server.

What is claimed is:

1. A communication apparatus connected to a first network on which one or more service providing servers are disposed, comprising:
a service finder configured to find a service providing server on the first network; and
a transmitter configured to transmit an information packet including a header part and a data part to a packet relay apparatus which connects the first network to a second network, wherein the header part contains
an address of the found service providing server and a port number at which the found service providing server waits, as a source address and a source port number and
an address of an information processing server disposed on the second network and a port number at which the information processing server waits, as a destination address and a destination port number, and
the data part contains service identification information which identifies a service provided by the found service providing server.

2. The apparatus according to claim 1, wherein
the transmitter transmits a first packet and a second packet as the information packet,
the first packet has a header part containing an address of the found service providing server and a port number at which the found service providing server waits as a source address and a source port number and containing an address of the information processing server and a port number at which the information processing server waits as a destination address and a destination port number, and
the second packet has a header part containing the address of the information processing server and the port number at which the information processing server waits, as a destination address and a destination port number and containing own address and a port number specified beforehand as a source address and a source port number, and a data part containing the service identification information.

3. The apparatus according to claim 2, wherein
the transmitter first transmits the second packet, and
upon receiving a transmission request packet to request transmission of the first packet from the information processing server which has received the second packet, the transmitter transmits the first packet.

4. The apparatus according to claim 3 wherein
the transmitter transmits the first packet periodically, and
upon receiving a stop request packet to request stop of transmission of the first packet from the information processing server, the transmitter stops transmission of the first packet.

5. The apparatus according to claim 2, wherein
the transmitter transmits the first packet periodically, and
upon receiving a stop request packet to request stop of transmission of the first packet from the information processing server, the transmitter stops transmission of the first packet.

6. The apparatus according to claim 1, wherein
the transmitter transmits the information packet periodically, and
upon receiving a stop request packet to request stop of transmission of the information packet from the information processing server, the transmitter stops transmission of the information packet.

7. The apparatus according to claim 1, wherein
the transmitter transmits a packet for inquiring the address of the information processing server and the port number at which the information processing server waits, toward an information management server disposed on the first network or the second network to manage the address of the information processing server and the port number at which the information processing server waits, and receives a packet containing a result of the inquiry from the information management server.

8. The apparatus according to claim 1, further comprising:
a receiver configured to receive a packet containing information to identify the services providing servers and information to identify services provided by the service providing servers from the information processing server;
a exhibitor configured to exhibit the information to identify the services providing servers; and
a selector configured to select a service providing server based on the information exhibited,
wherein the transmitter transmits a service request packet to request the information processing server to perform data communication concerning a service provided by the service providing server selected with the service providing server selected.

9. The apparatus according to claim 8, wherein the receiver receives a packet containing a result of the data communication from the information processing server

10. A communication system including a communication apparatus connected to a first network on which one or more service providing servers are disposed, and an information processing server connected to a second network which is connected to the first network via a packet relay apparatus, wherein
the communication apparatus comprises:
a service finder configured to find a service providing server on the first network; and
a transmitter configured to transmit an information packet including a header part and a data part to the packet relay apparatus, the header part containing an address of the found service providing server and a port number at which the found service providing server waits as a source address and a source port number and containing an address of the information processing server and a port number at which the information processing server waits as a destination address and a destination port number, the data part containing service identification information which identifies a service provided by the found service providing server, and
the information processing server comprises:
a receiver configured to receive the information packet from the communication apparatus via the packet relay apparatus;
an exhibitor configured to exhibit information to identify the service providing servers respectively;
a selector configured to select a service providing server based on the information exhibited; and
a transmitter configured to transmit a request packet to request implementation of the service provided by the service providing server selected to the service providing server selected, and perform data communication concerning said service with the service providing server selected, wherein the request packet has a header part containing an address of the service providing server selected and a port number at which the service providing server waits as a destination address and a destination port number and containing own address and a port number for implementing the data communication as a source address and a source port number.

11. The system according to claim 10, wherein
the transmitter in the communication apparatus transmits a first packet and a second packet as the information packet,
the first packet has a header part containing an address of the found service providing server and a port number at which the found service providing server waits as a source address and a source port number and containing an address of the information processing server and a port number at which the information processing server waits as a destination address and a destination port number,
the second packet has a header part containing the address of the information processing server and the port number at which the information processing server waits as a destination address and a destination port number and containing an address of the communication apparatus and a port number specified beforehand as a source address and a source port number, and a data part containing the service identification information, and
the header part of the request packet transmitted by the transmitter in the information processing server contains the source address and the source port number of the first packet as a destination address and a destination port number and contains the destination address and the destination port number of the first packet as a source address and a source port number.

12. The system according to claim 11, wherein
the transmitter in the communication apparatus first transmits the second packet, and
upon receiving a transmission request packet from the information processing server which has received the second packet to request transmission of the first packet, the transmitter in the communication apparatus transmits the first packet.

13. The system according to claim 12, wherein
the transmitter in the communication apparatus transmits the first packet periodically, and
upon receiving a stop request packet from the information processing server to request stop of transmission of the first packet, the transmitter in the communication apparatus stops transmission of the first packet.

14. The system according to claim 11, wherein
the transmitter in the communication apparatus transmits the first packet periodically, and
upon receiving a stop request packet from the information processing server to request transmission stop of the first packet, the transmitter in the communication apparatus stops transmission of the first packet.

15. The system according to claim 10, wherein
the transmitter in the communication apparatus transmits the information packet periodically, and
upon receiving a stop request packet from the information processing server to request stop of transmission of the information packet, the transmitter in the communication apparatus stops transmission of the information packet.

16. The system according to claim 10, wherein
the transmitter in the communication apparatus transmits a packet for inquiring the address of the information processing server and the port number at which the information processing server waits, toward an information management server disposed on the first network or the second network to manage the address of the information processing server and the port number at which the information processing server waits, and receives a packet containing a result of the inquiry from the information management server.

17. The system according to claim 10, wherein the communication apparatus further comprises:
a receiver configured to receive a packet containing information to identify the service providing servers and information to identify services provided by the service providing servers from the information processing server;
an exhibitor configured to exhibit the information to identify the service providing servers; and
a selector configured to select a service providing server based on information exhibited,
wherein the transmitter in the communication apparatus transmits a service request packet to request the information processing server to perform data communication concerning the service provided by the service providing server selected with the service providing server selected

18. The system according to claim 17, wherein the receiver in the communication apparatus receives a packet containing a result of the data communication from the information processing server.

19. A method performed in a communication apparatus connected to a first network on which one or more service providing servers are disposed, comprising:
finding a service providing server on the first network; and
transmitting an information packet including a header part and a data part to a packet relay apparatus which connects the first network to a second network, wherein the header part contains an address of the found service providing server and a port number at which the found service providing server waits as a source address and a source port number, and an address of an information processing server disposed on the second network and a port number at which the information processing server waits as a destination address and a destination port number, and the data part contains service identification information which identifies a service provided by the found service providing server.

20. A computer readable medium storing a computer program for causing a computer connected to a first network on which one or more service providing servers are disposed, to execute instructions to perform steps of:
finding a service providing server on the first network; and
transmitting an information packet including a header part and a data part to a packet relay apparatus which connects the first network to a second network, wherein the header part contains an address of the found service providing server and a port number at which the found service providing server waits as a source address and a source port number, and an address of an information processing server disposed on the second network and a port number at which the information processing server waits as a destination address and a destination port number, and the data part contains service identification information which identifies a service provided by the found service providing server.
